(19) United States
(12) Patent Application Publication
(10) Pub. No.: US 2019/0019505 A1
(43) Pub. Date: Jan. 17, 2019

(54) SUSTAINING CONVERSATIONAL SESSION

(71) Applicant: Lenovo (Singapore) Pte. Ltd., Singapore (SG)

(72) Inventors: John Weldon Nicholson, Cary, NC (US); Daryl Cromer, Cary, NC (US); Krishna C. Garikipati, Chicago, IL (US); Dusan Macho Cierna, Arlington Heights, IL (US)

(21) Appl. No.: 15/647,862

(22) Filed: Jul. 12, 2017

(51) Int. Cl. G10L 15/22; G10L 25/78

(52) U.S. Cl. CPC G10L 15/22; G10L 2015/223; G10L 25/78

(57) ABSTRACT

One embodiment provides a method, including: receiving, at an information handling device, an indication to initiate a conversational session with a user; receiving, from the user, a query input; completing, using a processor, a function associated with the received query input; and sustaining, at the information handling device, the conversational session after completing the function. Other aspects are described and claimed.

### BACKGROUND

Information handling devices (“devices”), for example smart phones, tablet devices, smart speakers, laptop and personal computers, and the like, may be capable of receiving command inputs and providing outputs responsive to the inputs. Generally, a user interacts with a voice input module, for example embodied in a personal assistant through use of natural language. This style of interface allows a device to receive voice inputs from a user (e.g., queries, commands, etc.), process those inputs, and provide audible outputs according to preconfigured output settings (e.g., preconfigured output speed, etc.). Once the device has provided the appropriate output, the device completes the session.

### BRIEF SUMMARY

In summary, one aspect provides a method, comprising: receiving, at an information handling device, an indication to initiate a conversational session with a user; receiving, from the user, a query input; completing, using a processor, a function associated with the received query input; and sustaining, at the information handling device, the conversational session after completing the function.

Another aspect provides an information handling device, comprising: a processor; a memory device that stores instructions executable by the processor to: receive an indication to initiate a conversational session with a user; receive, from the user, a query input; complete a function associated with the received query input; and sustain the conversational session after completing the function.

A further aspect provides a product, comprising: a storage device that stores code, the code being executable by a processor and comprising: code that receives an indication to initiate a conversational session with a user; code that receives, from the user, a query input; code that completes, using a processor, a function associated with the received query input; and code that sustains the conversational session after completing the function.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of sustaining a conversational session after completion of a function associated with a query input.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Users frequently utilize devices to execute a variety of different commands or queries. One method of interacting with a device is to use digital assistant software employed on the device (e.g., Siri® for Apple®, Cortana® for Windows®, Alexa® for Amazon®, etc.). Digital assistants are able to provide outputs (e.g., audible outputs, visual outputs, etc.) that are responsive to a variety of different types of user inputs (e.g., voice inputs, etc.).

In conventional digital assistant sessions, the user provides a query input and the assistant performs a function associated with that input. The term query input will be used here throughout. However, it should be understood by one skilled in the art that query input does not necessarily mean a question to the digital assistant. For example, the user may provide a command, for example, “dim the lights”, for the assistant to process and complete. In other words, a query input includes an input provided to a digital assistant for processing, whether that is a question, command, or other type of input.

Conventional assistant software can generally process single-turn conversations or multi-turn conversations. A single-turn conversation can be processed with one request from a user. In other words, the user provides a single query input and the digital assistant can completely process the request. A multi-turn conversation includes more than one exchange between the user and digital assistant. For example, the user may provide an input and the digital assistant may then request more information which the user then provides. For example, a user may command a digital assistant to order a pizza. Responsive to receiving this command, the digital assistant may ask the user a series of successive questions that require additional user input (e.g., “where did you want to order the pizza from?”, “what size pizza did you want to order?”, “what kinds of toppings do you want on your pizza?”, etc.).

However, once the conversations are complete, e.g., the digital assistant has processed the request, the digital assistant then has to be woken or activated again before receiving additional user input. For example, using the pizza example above, once the digital assistant has placed the order, the digital assistant considers the conversation complete and stops “listening” for user input. Additionally, conventional digital assistants are not aware of contexts that would likely lead to a user providing a query input. For example, when a user picks up a mobile device, the user may be picking up the device in order to provide input to a digital assistant. However, using conventional techniques, the user has to provide the digital assistant activation input (e.g., wake-up word, wake-up action, etc.) before the digital assistant will be active to listen for a query input.

Accordingly, an embodiment provides a method of sustaining a conversational session after completion of a function associated with a provided query input. An embodiment may receive an indication to initiate a conversational session with a user. In one embodiment the indication to initiate a conversational session may include the conventional activation input (e.g., wake-up word, wake-up action, etc.). In one embodiment, the indication may include a change in the state of the information handling device. For example, the system may identify that a communication (e.g., text message, telephone call, instant message, etc.) has been received at the device. An embodiment may then activate the digital assistant in response to receipt of this communication.

After initiating the conversational session with the user, the system may receive a query input from a user to perform some function. Once the system has processed the query input and completed the function associated with the query input, an embodiment may sustain the conversational session after completing the function after completion of the function. An embodiment may then wait for additional user input. The additional user input may include an additional query input or may include an input of a predetermined phrase indicating that the user is done with the digital assistant, for example, the user may provide the input “bye”, “ok, thank you”, “I'm finished”, or the like. In one embodiment, after not receiving user input for the predetermined time period, the digital assistant may “time-out” and stop listening for user input. Such a method may assist a user in conversing with a digital assistant by not requiring the user to provide the activation input every time the user wants the digital assistant to perform some function.

The illustrated example embodiments will be best understood by reference to the figures. The following description is intended only by way of example, and simply illustrates certain example embodiments.

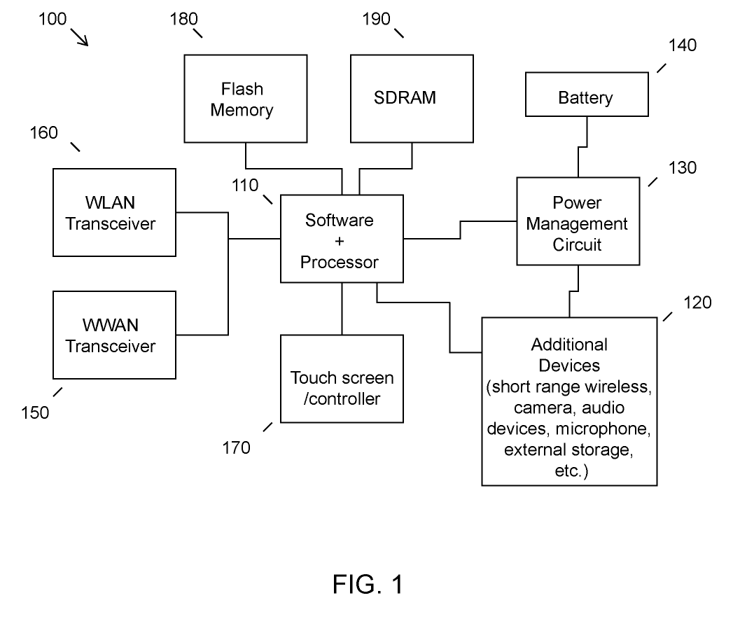

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera. System 100 often includes a touch screen 170 for data input and display/rendering. System 100 also typically includes various memory devices, for example flash memory 180 and SDRAM 190.

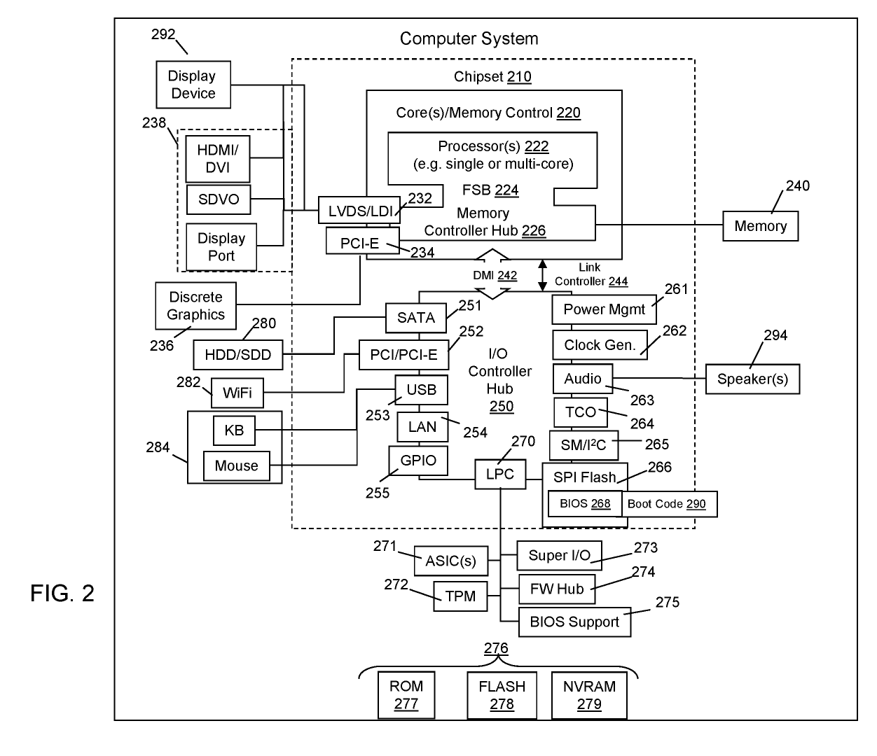

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, smart speakers, personal computer devices generally, and/or electronic devices which enable users to communicate with a digital assistant. For example, the circuitry outlined in FIG. 1 may be implemented in a tablet or smart phone embodiment, whereas the circuitry outlined in FIG. 2 may be implemented in a personal computer embodiment.

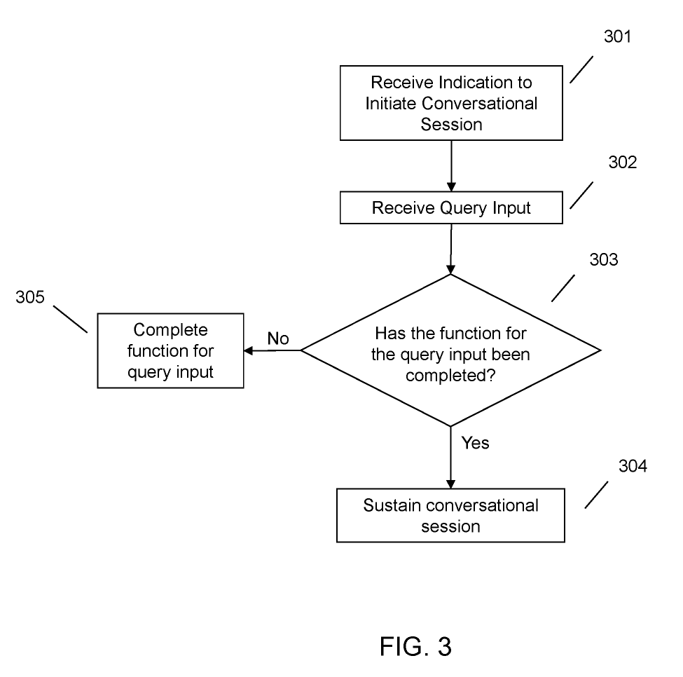

Referring now to FIG. 3, at 301, an embodiment may receive, at an information handling device, an indication to initiate a conversational session with a user. A conversational session may be defined as a session with a digital assistant or other interactive application in which a user provides input, the digital assistant processes or analyzes the input, and the digital assistant then provides an output responsive to the input. A conversational session may include a single exchange of input and output, referred to herein as a single-turn conversational session, or multiple exchanges of input and output, referred to herein as a multi-turn interaction session.

In an embodiment, the indication to begin a conversational session may be associated with user-provided input. In an embodiment, the user-provided input indication may be a wakeup input or action provided by a user (e.g., one or more wakeup words or predetermined commands, a depression of a button for a predetermined length of time, a selection of a digital assistant icon, etc.). In an embodiment, the wakeup action may be provided prior to or in conjunction with user input. For example, a user may provide the vocal input, “Ok Surlexana, order a pizza.” In this scenario, “Ok Surlexana” is the wakeup word and upon identification of the wakeup word an embodiment may prime the system to listen for additional user input. Responsive to the identification of the wakeup action, an embodiment may initiate a conversational session. In another embodiment, the indication may not be associated with a wakeup action. For example, the system may simply “listen” to the user and determine when the user is providing input directed at the system. The conversational session may then be initiated when the system determines that the user input is directed to the system.

In an embodiment, the indication to initiate the conversational session may include an event associated with the user or information handling device. In one embodiment, the event may include a change in state of the information handling device. A change in state of the information handling device may include a change in orientation, power state, acceleration, motion, and the like, of the device. As an example, a change in state, and therefore an event, may include the device being plugged into or unplugged from A/C power. As another example, the change in state, and therefore an event, may include the device being moved, picked up, a specific motion, or the like. For example, a user may pick the mobile device up in a manner which indicates that the user is looking at the screen of the device. Not all changes in state of the information handling device may initiate a conversational session. For example, an embodiment may determine that the user has picked up the device and placed it in a pocket and may then determine that a conversational session should not be initiated.

In one embodiment, an event may include an application event. As an example, an application event may include the receipt of a communication (e.g., text message, phone call, instant message, video message, etc.). The receipt of a communication activates an application on the device, which can be considered an application event. In one embodiment not all types of communications may initiate a conversational session. For example, an embodiment may distinguish that receipt of text messages initiates a conversational session, while receipt of telephone calls does not initiate a conversational session. The types of communications that initiate conversational sessions may be a default setting, set by the user, or learned by the device. For example, the device may identify that a user usually activates the digital assistant after receiving a text message. Accordingly, an embodiment may associate text messages with automatic initiation of a conversational session.

Other types of application events are possible and contemplated. One type of application event may include an application event set by a user. For example, the user may set an alarm or timer. An embodiment may identify the activation of the alarm or completion of the timer as an application event. Another type of application event may include an event of an application on the device or accessible to the device. For example, the device may have access to the user's calendar. The calendar may include an event or meeting that the system may identify as initiating a conversational sessions. Thus, when the event occurs on the calendar, an embodiment may initiate a conversational session. As another example, if a user receives a notification alert, the device may activate the digital assistant to listen for a query input related to the notification alert.

The user may set different events to initiate a conversational session. For example, the user may choose specific applications or device state changes that should initiate a conversational session. Alternatively, as discussed above, the system may learn events that should initiate a conversational session. The events that initiate conversational sessions may also be user-dependent. For example, one user may indicate that certain events should initiate a conversational session, whereas another user having access to the device may choose other events to initiate conversational sessions. Alternatively, the system may learn the events for each user. Accordingly, an embodiment may also identify the user providing input to the device in order to identify if a conversational session should be initiated.

Once an embodiment has initiated the conversational session, an embodiment may receive a query input from the user at 302. During the conversational session, an embodiment may receive user input (e.g., voice input, touch input, etc.) including or associated with a user query or a user command, referred to herein as a query input, at a device (e.g., smart phone, smart speaker, tablet, laptop computer, etc.). In an embodiment, the device may employ digital assistant software capable of receiving and processing user input and subsequently providing output (e.g., audible output, textual output, visual output, etc.) corresponding or responsive to the user input. In an embodiment, the user input may be any input that requests the digital assistant to provide a response. For example, the user may ask the digital assistant a general question about a topic, the user may ask the digital assistant to provide instructions to assemble an object, the user may ask the digital assistant's opinion on a topic, the user may make a statement which allows a response, and the like.

The input may be received at an input device (e.g., physical keyboard, on-screen keyboard, audio capture device, image capture device, video capture device, etc.) and may be provided by any known method of providing input to an electronic device (e.g., touch input, text input, voice input, etc.). For simplicity purposes, the majority of the discussion herein will involve voice input that may be received at an input device (e.g., a microphone, a speech capture device, etc.) operatively coupled to a speech recognition device. However, it should be understood that generally any form of user input may be utilized. For example, the user may provide text input to the digital assistant, for example, through a chat assistant or instant messaging application.

In an embodiment, the input device may be an input device integral to the digital assistant device. For example, a smart phone may be disposed with a microphone capable of receiving voice input data. Alternatively, the input device may be disposed on another device and may transmit received input data to the digital assistant device. For example, voice input may be received at a smart speaker that may subsequently transmit the voice data to another device (e.g., to a user's smartphone for processing, etc.). Input data may be communicated from other sources to the digital assistant device via a wireless connection (e.g., using a BLUETOOTH connection, near field communication (NFC), wireless connection techniques, etc.), a wired connection (e.g., the device is coupled to another device or source, etc.), through a connected data storage system (e.g., via cloud storage, remote storage, local storage, network storage, etc.), and the like.

In an embodiment, the input device may be configured to continuously receive input data by maintaining the input device in an active state. The input device may, for example, continuously detect input data even when other sensors (e.g., cameras, light sensors, speakers, other microphones, etc.) associated with the digital assistant device are inactive. Alternatively, the input device may remain in an active state for a predetermined amount of time (e.g., 30 minutes, 1 hour, 2 hours, etc.). Subsequent to not receiving any input data during this predetermined time window, an embodiment may switch the input device to a power off state. The predetermined time window may be preconfigured by a manufacturer or, alternatively, may be configured and set by one or more users.

At 303 the system may determine whether the function associated with the received query input has been completed. In an embodiment, the digital assistant device, or another device associated with the digital assistant device, may perform at least one output function responsive to the user input. In an embodiment, the output function may comprise the provision of output, the performance of a task, a combination thereof, and the like. Regarding the provision of output, the output may be audio output, visual output, a combination thereof, or the like. In an embodiment, audible output may be provided through a speaker, another output device, and the like. In an embodiment, visual output may be provided through a display screen, another display device, and the like.

In an embodiment, the output device may be integral to the speech recognition device or may be located on another device. In the case of the latter, the output device may be connected via a wireless or wired connection to the digital assistant device. For example, a smart phone may provide instructions to provide audible output through an operatively coupled smart speaker. Regarding the performance of a task, the task may be virtually any task that is capable of being executed by one or more devices. For example, an embodiment may dim the lights in the room, change a television channel, commence a financial transaction, and the like.

After performing an action associated with the query input an embodiment may determine whether the purpose behind the query input has been achieved. In other words, an embodiment may determine whether the exchange in relation to the query input has been completed. For example, in a multi-turn conversation, the device may identify that the last exchange completed the multi-turn conversation. Using the pizza example of above, once the pizza has been ordered the device may identify this point as the completion of the function associated with the query input. As a contrasting example, the action of the device to request additional information from the user would comprise an action that does not complete the function associated with the query input. As another example, in a single-turn conversation, after the system has responded to the user's query input, the function associated with the query input would be considered completed. For example, if the user provided the input “dim the lights”, once the device dims the lights, the function associated with the query input would be completed.

In one embodiment completing a function associated with the received query input may be responsive to determining the query input is associated with the event that initiated the conversational session. In other words, in the case that an event initiated the conversational session, an embodiment may determine that the query input is associated with the event. If the system determines that the query input is associated with the event, then the system may perform the function associated with the query input. As an example, if an embodiment receives a text message which triggers the conversational session, and then receives user input stating “respond, ok”, the device may determine that the query input is associated with the text message. Thus, the device may identify that the input received from the user was directed at the device and the device should perform a function.

As a contrasting example, if an embodiment receives a text message and then receives user input stating “What's for dinner?”, an embodiment may determine that the input is not associated with the text message and may not perform any actions in response to the user input. Such a technique provides that the user does not have to provide a wake-up action at all in order for the digital assistant to be activated and perform a function. Rather, the event triggered the digital assistant and because the input is associated with the event, the digital assistant can determine that the input is directed at the digital assistant.

If an embodiment determines that the function associated with the query input has not been completed at 303, the system may continue exchanges with the user until the function associated with the query input has been completed at 305, for example, in the case of multi-turn conversations. Alternatively, the device may just need to perform the function, rather than requiring any more input from the user to complete the function. If, however, an embodiment determines that the function associated with the query input has been completed at 303, an embodiment may sustain the conversational session after completing the function, at 304, after the function has been completed.

Sustaining the conversational session may include keeping the digital assistant activated for a time period after completion of the function associated with the query input. This provides a technique where the user does not have to provide an activation action in order to reactive the digital assistant after just conversing with the assistant. Thus, the assistant may continue to listen for a command or additional query input after completion of the first command or query input. The time period after completion of the function may be a default time period, set by the user, learned by device. The conversational session may then end after the predetermined time period has expired or may be terminated based upon another factor, for example, identifying input provided to another user, receiving a predetermined command, or the like.

In either the case where the conversational session is extended or the digital assistant is activated in response to an event, an embodiment may distinguish between input provided to the assistant and input provided to another person. For example, if a user talks to another person in the room, the digital assistant needs to determine whether the user is directing the input to the digital assistant for processing. To make this determination, an embodiment may use a model for detecting whether the user is still talking to the assistant or to someone else. This model may be informed by contextual information related to the environment of the device and user. Contextual information may include any information which allows the device to determine if the input is directed at the device. For example, contextual information may include determining whether another person is the room (e.g., detected through thermal information, detected using speech detection, detected using a camera, etc.), whether the user is using another device (e.g., talking on the telephone, providing input to a television, etc.), how far the user is from the device (e.g., a further distance may indicate the input is not directed to the device), and the like.

Additionally or alternatively, an embodiment may determine the intent of the query input to determine if the input is directed at the device. An embodiment may use natural language processing to determine the intent of the query input. One embodiment may use an intent mapper or domain classifier to determine if the digital assistant can understand the input. If the device determines that the input is not directed at the device, the device may provide no output. If the device incorrectly determined that the input was not directed at the assistant, the user may just provide a predetermined phrase or activation action to activate the assistant to perform the desired function. For example, if a user provided input to the device and the device “ignored” the input, the user may just provide the input “Surlexana”, “Hello? Are you listening?”, or the like, to activate the device to perform the requested action.

Ending the conversational session may be based upon receipt of a predetermined command or query input. In other words, to end the conversational session, the user may provide additional query input that indicates the conversational session should be completed. For example, the additional query input may include a predetermined command that identifies the end of the conversational session (e.g., “bye”, “thanks”, “I'm done”, “go back to sleep”, etc.). The end of the conversational session may also be identified by a predetermined action or gesture, for example, the user may wave at the device to end the session. The predetermined command, action, or gesture may be a default command, action, or gesture, set by the user, or learned by the device. Upon identifying the conversational session has ended the device may be deactivated until another activation trigger occurs which activates the digital assistant.

The various embodiments described herein thus represent a technical improvement to conventional communications with a digital assistant. Using the methods and systems as described herein, the user does not have to provide an activation action to activate the digital assistant. Rather, the digital assistant can identify situations where the user will likely request an action from the digital assistant. Additionally, after the user has provided instructions and a function has been completed by the digital assistant, the user does not have to provide the activation action again to activate the digital assistant. Such techniques enable a more intuitive digital assistant that does not require the user to provide unnecessary activation actions.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an information handling device, an indication to initiate a conversational session with a user;
receiving, from the user, a query input;
completing, using a processor, a function associated with the received query input; and
sustaining, at the information handling device, the conversational session after completing the function.

2. The method of claim 1, wherein the receiving an indication to initiate a conversational session comprises identifying an event.

3. The method of claim 2, wherein the event comprises a change in state of the information handling device.

4. The method of claim 2, wherein the completing a function associated with the received query input is responsive to determining the received query input is associated with the identified event.

5. The method of claim 1, further comprising receiving an additional query input to end the conversational session.

6. The method of claim 5, wherein the receiving an indication to end comprises receiving, from a user, a predetermined command.

7. The method of claim 5, wherein the receiving an indication to end comprises receiving user input and determining the user input is not directed at the information handling device.

8. The method of claim 7, wherein the determining comprises using contextual information associated with the user input.

9. The method of claim 1, further comprising ending the conversational session after expiration of the predetermined time period.

10. The method of claim 1, wherein the receiving an indication to initiate a conversational session comprises receiving a predetermined command.

11. An information handling device, comprising:
a processor;
a memory device that stores instructions executable by the processor to:
receive an indication to initiate a conversational session with a user;
receive, from the user, a query input;
complete a function associated with the received query input; and
sustain the conversational session after completing the function.

12. The information handling device of claim 11, wherein the instructions executable by the processor to receive an indication to initiate a conversational session comprises instructions executable by the processor to identify an event.

13. The information handling device of claim 12, wherein the event comprises a change in state of the information handling device.

14. The information handling device of claim 12, wherein the instructions executable by the processor to complete a function associated with the received query input is responsive to determining the received query input is associated with the identified event.

15. The information handling device of claim 11, wherein the instructions executable by the processor further comprise instructions to receive an additional query input to end the conversational session.

16. The information handling device of claim 15, wherein the instructions executable by the processor to receive an indication to end comprises instructions executable by the processor to receive, from a user, a predetermined command.

17. The information handling device of claim 15, wherein the instructions executable by the processor to receive an indication to end comprises instructions executable by the processor to receive user input and determining the user input is not directed at the information handling device.

18. The information handling device of claim 11, wherein the instructions executable by the processor further comprise instructions executable by the processor to end the conversational session after expiration of the predetermined time period.

19. The information handling device of claim 11, wherein the instructions executable by the processor to receive an indication to initiate a conversational session comprises instructions executable by the processor to receive a predetermined command.

20. A product, comprising:
a storage device that stores code, the code being executable by a processor and comprising:
code that receives an indication to initiate a conversational session with a user;
code that receives, from the user, a query input;
code that completes, using a processor, a function associated with the received query input; and
code that sustains the conversational session after completing the function.
